(19) United States
(12) Patent Application Publication
(10) Pub. No.: US 2016/0319079 A1
(43) Pub. Date: Nov. 3, 2016

(54) CROSS-LINKABLE SILICONE COMPOSITION

(71) Applicant: Wacker Chemie AG, Munich, DE (US)

(72) Inventors: Andreas KOELLNBERGER, Kirchdorf (DE); Erich PILZWEGER, Julbach (DE)

(21) Appl. No.: 15/104,652

(22) PCT Filed: Dec. 17, 2013
(86) PCT No.: PCT/EP2013/076993

§ 371 Date: Jun. 15, 2016

(51) Int. Cl. C08G 77/38

(52) U.S. Cl. CPC C08G 77/38

(57) ABSTRACT

Silicone elastomers exhibiting non-transitory biofilm inhibiting properties are prepared from crosslinkable components which include an organopolysiloxane bearing at least one silicon-bonded hydrogen and/or at least one alkenyl group, and at least one carboxylic acid, carboxylic acid ester, or carboxylic acid anhydride group, which becomes covalently bonded to the polymer before or during curing.

### CROSS REFERENCE TO RELATED APPLICATIONS

This application is the U.S. National Phase of PCT Appln. No. PCT/EP2013/076993 filed Dec. 17, 2013, the disclosure of which is incorporated in its entirety by reference herein.

### BACKGROUND OF THE INVENTION

1. Field of the Invention

The present invention relates to a modified silicone composition, and to the silicone elastomers produced therefrom by curing, which delay or prevent the formation of a biofilm on their surface.

2. Description of the Related Art

In the medical sector, numerous products made from silicone are used, for example face masks, valves, hoses, catheters, lining materials, bandages, prostheses, dressing materials, implants, etc. For all applications, in the course of the use period, an occupation of the surface with bacteria can take place which, in some cases, can lead to infections. In this connection, antibiotic-resistant bacterial strains are a growing problem since they lead to infections that are difficult to treat. The first step for an occupation is the adhesion of the bacteria to the exogenous surface. Following colonization, biofilm formation can result which is particularly problematic because the endogenous immune system or antibiotics can only attack the bacteria with very great difficulty through the protection of the biofilm.

The admixing or coating of bactericidally effective substances forms part of the prior art for medical products, with the very administration of non-lethal antibiotic doses promoting the replication of resistant bacteria. Often, antibiotics, quaternary ammonium compounds, silver ions or silver or iodine are added, where the solubility in water leads to the washing out of the active substances, which, in the case of a controlled release system, leads to the killing of bacteria in the surrounding area of the implant and/or the component. As a result of the leaching out, the active substance is gradually used up, such that the entire system can no longer be antibacterially effective after some time.

WO2009/019477A2 describes, as a further option, the coating of a medical implant with a biodegradable layer which consists of a polymer and an acid-acting additive which is mixed into the polymer. A disadvantage of this technology is the ineffectiveness at a damaged site if the coating is detached from the substrate. Moreover, the active substance is here too washed out as a result of contact with bodily fluids and loses its effectiveness over a certain period.

In WO98/50461, elemental silver is mixed into a coating in the form of a powder in order to achieve an antimicrobial effect. In the case of silver-containing products, there is the risk that contact with bodily fluids containing S—H groups will reduce the effective concentration of the silver ions, and the lethal dose will no longer be able to be achieved which in turn leads to a product which is antimicrobially ineffective.

EP0022289B1 describes antimicrobial polymer compositions which are used in the medical sector. Here, a releasable amount of a carboxylate agent is added to the polymer base materials. This too leads to the disadvantages specified above.

The patent specification WO2008/140753A1 describes an implant which is antimicrobially and fungicidally equipped through impregnation with parabens. On account of the lack of covalent bonding to the matrix of the implant, the active substance is released to the surrounding area within a short period in the case of this application too (drug-release system).

All of the solutions proposed hitherto in the prior art for the antibacterial equipping of medical products for preventing the formation of biofilms exhibit the major disadvantage that the antimicrobial substances are washed out as a result of the contact with media such as water or bodily fluids. As a result, the active groups or ions or molecules on the surface of the medical products become depleted and the surface inhibition of the biofilm formation is reduced in its effect.

### SUMMARY OF THE INVENTION

It was therefore an object of the present invention to provide silicone compositions which are able to suppress or to inhibit bacteria and/or fungus or algae growth on the surface of crosslinked silicone elastomers produced therefrom, and without leaching or extraction of the active component taking place. Such crosslinked products are consequently protected against the occupation and the attack of microorganisms. This object was achieved by a crosslinkable silicone composition which comprises at least one silicone compound (X) of the general formula (I)

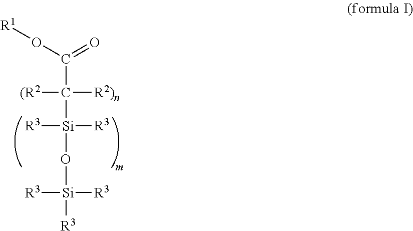

where
R¹ is hydrogen, or a monovalent radical optionally containing heteroatoms, such as alkyl-, aryl-, arylalkyl-, alkylaryl-, SiR⁷₃—, polydimethylsiloxane-,
R² identical or different, are hydrogen, or a monovalent radical optionally containing heteroatoms, such as alkyl-, aryl-, arylalkyl-, alkylaryl-, R⁸COOR¹,
R³ identical or different, are a hydrogen, a monovalent radical optionally containing heteroatoms, such as alkenyl-, alkenylaryl-, alkyl-, aryl-, arylalkyl-, alkylaryl-, —OSiR⁷₃,
R⁷ is a monovalent radical optionally containing heteroatoms, such as alkenyl-, alkenylaryl-, alkyl-, aryl-, arylalkyl-, alkylaryl-, —OSiR⁷₃,
R⁸ is a bivalent alkyl radical,
n is a number between 1 and 30,
m is a number between 0 and 6000,

with the proviso that, per molecule of the compound (X), at least one R³ is an aliphatically unsaturated double bond or a hydrogen atom; preferably at least two R³ are an aliphatically unsaturated double bonds or hydrogen atoms, and more preferably at least three R³ are aliphatically unsaturated double bonds or hydrogen atoms, and

with the proviso that the silicone compound (X) is used in amounts such that the silicone composition comprises between 0.005 mmol/g and 2 mmol/g of carboxylic acid groups, carboxylic acid esters, or carboxylic anhydrides hydrolyzable to give carboxylic acids, based on the acid group; preferably between 0.01 mmol/g and 1 mmol/g, more preferably between 0.02 mmol/g and 0.085 mmol/g and most preferably between 0.04 mmol/g and 0.7 mmol/g.

### DETAILED DESCRIPTION OF THE PREFERRED EMBODIMENTS

The silicone compound (X) contains at least one functional group in the siloxane moiety which completes a bonding to the silicone matrix during the crosslinking. The product of the crosslinking reaction is therefore a silicone elastomer, for example a polydimethylsiloxane network modified by acidic groups. The antimicrobially effective groups or agents are covalently bonded to the silicone matrix and the silicone elastomer consequently does not exhibit the specified disadvantages detailed in the prior art. Consequently, the leaching out or extraction of the active component is no longer possible. It is a further advantage that an undesired contamination of objects or media which come into contact with the silicone elastomer is prevented.

The acidic effect of the compound (X) is based on the fact that it contains a carboxylic acid function which can be present either in unprotected form or in the form of a carboxylic acid ester.

Examples of R¹ for alkyl radicals are the methyl, ethyl, propyl, isopropyl, tert-butyl, n-pentyl, isopentyl, neopentyl, tert-pentyl, n-octyl, 2-ethylhexyl, 2,2,4-trimethylpentyl, n-nonyl and octadecyl radicals; cycloalkyl radicals such as the cyclopentyl, cyclohexyl, cycloheptyl, norbornyl, adamantylethyl or bornyl radicals; aryl or alkaryl radicals such as the phenyl, ethylphenyl, tolyl, xylyl, mesityl or naphthyl radicals; and aralkyl radicals such as the benzyl, 2-phenylpropyl or phenylethyl radical. Examples of R¹ with heteroatoms are derivatives of the above radicals that are halogenated and/or functionalized with organic groups, such as the 3,3,3-trifluoropropyl, 3-iodopropyl, 3-isocyanatopropyl, aminopropyl, methacryloxymethyl or cyanoethyl radicals, silyl radicals such as trimethylsilyl, tert-butyldimethylsilyl, tetraethylsilyl, triisopropylsilyl, and tert-butyldiphenylsilyl, polydimethylsiloxane radicals such as trimethylsilyl- or vinyldimethyl-terminated polydimethylsiloxanes, trimethylsilyl- or vinyldimethyl-terminated polydimethylsiloxane-vinylmethylsiloxane copolymers, trimethylsilyl- or vinyldimethyl-terminated polydimethylsiloxane-hydrogenmethylsiloxane copolymers, trimethylsilyl- or vinyldimethyl-terminated polydimethylsiloxane-phenylmethylsiloxane copolymers or trimethylsilyl- or vinyldimethyl-terminated polydimethylsiloxane-phenylmethylsiloxane-methylhydrogensiloxane copolymers. If R¹ is hydrogen and at the same time one R² contains a carboxyl group, the anhydride of the two carboxyl groups can be formed and/or used. If R¹ is hydrogen and at the same time one R² contains a hydroxyl group, the internal ester (=lactone) possible from the two functionalities can be formed and/or used.

Preferred radicals R¹ are the methyl, ethyl, phenyl, silyl and polydimethylsiloxane radicals, and anhydrides or lactones of further carboxyl or hydroxyl groups present in the same molecule. Particularly preferred radicals R¹ are the silyl and polydimethylsiloxane radicals, and anhydrides or lactones of further carboxyl or hydroxyl groups present in the same molecule.

Examples of R² for alkyl radicals are the methyl, ethyl, propyl, isopropyl, tert-butyl, n-pentyl, isopentyl, neopentyl, tert-pentyl, n-octyl, 2-ethylhexyl, 2,2,4-trimethylpentyl, n-nonyl and octadecyl radicals; cycloalkyl radicals such as the cyclopentyl, cyclohexyl, cycloheptyl, norbornyl, adamantylethyl or bornyl radical; aryl or alkaryl radicals such as the phenyl, ethylphenyl, tolyl, xylyl, mesityl or naphthyl radicals; and aralkyl radicals such as the benzyl, 2-phenylpropyl or phenylethyl radicals. Examples of R² with heteroatoms are derivatives of the above radicals that are halogenated and/or functionalized with organic groups, such as the 3,3,3-trifluoropropyl, 3-iodopropyl; 3-isocyanatopropyl, aminopropyl, methacryloxymethyl or cyanoethyl radicals, alkylcarboxy radicals such as —(CH₂)ₙ—COOH, —(CH₂)ₙ—COOSiMe₃, —(CH₂)ₙ—COOSiEt₃, —(CH₂)ₙ—COOSiⁱPr₃, —(CH₂)ₙ—COOSi^{t}Bu₃, —(CH₂)ₙ—COO-trimethylsilyl- or vinyldimethyl-terminated polydimethylsiloxanes, —(CH₂)ₙ—COO-trimethylsilyl- or vinyldimethyl-terminated polydimethylsiloxane-vinylmethylsiloxane copolymers, —(CH₂)ₙ—COO-trimethylsilyl- or vinyldimethyl-terminated polydimethylsiloxane-hydrogenmethylsiloxane copolymers, —(CH₂)ₙ—COO-trimethylsilyl- or vinyldimethyl-terminated polydimethylsiloxane-phenylmethylsiloxane copolymers, —(CH₂)ₙ—COO-trimethylsilyl- or vinyldimethyl-terminated polydimethylsiloxane-phenylmethylsiloxane-methylhydrogensiloxane copolymers, hydroxyalkyl radicals such as —(CH₂)ₙ—OH, where n can assume the values listed above.

If R¹ is hydrogen and at the same time one R² contains a carboxyl group not converted to carboxylic acid esters, the anhydride of the two carboxyl groups can be formed and/or used. If R¹ is hydrogen and at the same time one R² contains a hydroxyl group, the internal ester (=lactone) possible from the two functionalities can be formed and/or used.

Preferred radicals R² are the hydrogen, methyl, ethyl, phenyl, silyl and polydimethylsiloxane radicals, and anhydrides or lactones of further carboxyl or hydroxyl groups present in the same molecule. Particularly preferred radicals R² are silyl and polydimethylsiloxane radicals, and anhydrides or lactones of further carboxyl or hydroxyl groups present in the same molecule.

Examples of R³ for alkyl radicals are the methyl, ethyl, propyl, isopropyl, tert-butyl, n-pentyl, isopentyl, neopentyl, tert-pentyl, n-octyl, 2-ethylhexyl, 2,2,4-trimethylpentyl, n-nonyl and octadecyl radicals; cycloalkyl radicals such as the cyclopentyl, cyclohexyl, cycloheptyl, norbornyl, adamantylethyl or bornyl radicals; aryl or alkaryl radicals such as the phenyl, ethylphenyl, tolyl, xylyl, mesityl or naphthyl radicals; and aralkyl radicals such as the benzyl, 2-phenylpropyl or phenylethyl radicals. Examples of R³ with heteroatoms are derivatives of the above radicals that are halogenated and/or functionalized with organic groups, such as the 3,3,3-trifluoropropyl, 3-iodopropyl, 3-isocyanatopropyl, aminopropyl, methacryloxymethyl or cyanoethyl radicals, alkenyl and/or alkynyl radicals such as the vinyl, allyl, isopropenyl, 3-butenyl, 2,4-pentadienyl, butadienyl, 5-hexenyl, undecenyl, ethynyl, propynyl and hexynyl radicals; cycloalkenyl radicals such as the cyclopentenyl, cyclohexenyl, 3-cyclohexenylethyl, 5-bicycloheptenyl, norbornenyl, 4-cyclooctenyl or cyclooctadienyl radicals; alkenylaryl radicals, such as styryl or styrylethyl radical, and also derivatives of the above radicals that are halogenated and/or contain heteroatoms, such as the 2-bromovinyl, 3-bromo-1-propynyl, 1-chloro-2-methylallyl, 2-(chloromethyl)allyl, styryloxy, allyloxypropyl, 1-methoxyvinyl, cyclopentenyloxy, 3-cyclohexenyloxy, acryloyl, acryloyloxy, methacryloyl or methacryloyloxy radicals, and also —O—SiR₃. Preferred radicals R³ are the hydrogen, methyl, phenyl, vinyl and 3,3,3-trifluoropropyl radicals, with the —O—SiR₃ radical of these radicals also being preferred. Particularly preferred radicals R³ are the methyl and vinyl radicals, with the —O—SiR₃ radical also being preferred.

Examples of R⁷ are alkyl radicals such as the methyl, ethyl, propyl, isopropyl, tert-butyl, n-pentyl, isopentyl, neopentyl, tert-pentyl, n-octyl, 2-ethylhexyl, 2,2,4-trimethylpentyl, n-nonyl and octadecyl radicals; cycloalkyl radicals such as the cyclopentyl, cyclohexyl, cycloheptyl, norbornyl, adamantylethyl or bornyl radicals; aryl or alkaryl radicals such as the phenyl, ethylphenyl, tolyl, xylyl, mesityl or naphthyl radicals; and aralkyl radicals such as the benzyl, 2-phenylpropyl or phenylethyl radicals. Further examples of R⁷ are derivatives of the above radicals that are halogenated and/or functionalized with organic groups, such as the 3,3,3-trifluoropropyl, 3-iodopropyl, 3-isocyanatopropyl, aminopropyl, methacryloxymethyl or cyanoethyl radicals, alkenyl and/or alkynyl radicals such as the vinyl, allyl, isopropenyl, 3-butenyl, 2,4-pentadienyl, butadienyl, 5-hexenyl, undecenyl, ethynyl, propynyl and hexynyl radicals; cycloalkenyl radicals such as the cyclopentenyl, cyclohexenyl, 3-cyclohexenylethyl, 5-bicycloheptenyl, norbornenyl, 4-cyclooctenyl or cyclooctadienyl radicals; alkenylaryl radicals such as the styryl or styrylethyl radicals, and derivatives of the above radicals that are halogenated and/or contain heteroatoms, such as the 2-bromovinyl, 3-bromo-1-propynyl, 1-chloro-2-methylallyl, 2-(chloromethyl)allyl, styryloxy, allyloxypropyl, 1-methoxyvinyl, cyclopentenyloxy, 3-cyclohexenyloxy, acryloyl, acryloyloxy, methacryloyl or methacryloyloxy radicals. Preferred radicals R⁷ are the methyl, ethyl, isopropyl, tert-butyl, phenyl radicals. Particularly preferred radicals R⁷ are the methyl, ethyl, and phenyl radicals.

Examples of R⁸ are bivalent alkyl radicals such as methylene, ethylene, propylene, butylene, pentylene or hexylene radicals, as well as derivatives of the above radicals that are halogenated and/or functionalized with organic groups. Preferred radicals R⁸ are the methylene and ethylene radicals. Particular preference is given to the methylene radical.

The index n is a number between 1 and 30, preferably between 1 and 18, and more preferably between 1 and 5. The index m refers to the degree of polymerization of the siloxane moiety, where m is a number between 0 and 6000, preferably between 0 and 1000 and more preferably between 1 and 100.

The preparation of the compound (X) can take place in various ways, with the synthesis route having no influence on the effectiveness. It is possible, for example, to use any synthesis routes which have hitherto been described in textbooks and/or publications.

As a class of starting substances for the synthesis of the compound (X), it is possible to use carboxylic acids and derivatives thereof, which are reacted in one or more stages to give the compound (X). Nonlimiting examples of suitable carboxylic acids and derivatives thereof are: formic acid, ethanoic acid, oxoethanoic acid, propanoic acid, propenoic acid, propynoic acid, butanoic acid, 2-butenoic acid, 2-butynoic acid, 3-butenoic acid, 3-butynoic acid, crotonic acid, fumaric acid, cyclopropanecarboxylic acid, 2-methylpropanoic acid, acetylenedicarboxylic acid, 2,4-pentadienoic acid, 2-pentenoic acid, 3-pentenoic acid, 4-pentenoic acid, 2-pentynoic acid, 3-pentynoic acid, 4-pentynoic acid, 2-pentenedioic acid, 2-methylenesuccinic acid, acrylic acid, methacrylic acid, 3,3-dimethylacrylic acid, maleic acid, methylmaleic acid, succinic acid, allylsuccinic acid, cyclobutanoic acid, ethylmalonic acid, ethenylmalonic acid, ethynylmalonic acid, glutaric acid, 2-methylglutaric acid, 2-ethenylglutaric acid, 2-ethynylglutaric acid, trimethylsilylacetic acid, vinyldimethylsilylacetic acid, 2,4-hexadienoic acid, propene-1,2,3-tricarboxylic acid, 1-cyclopentene-carboxylic acid, 3-cyclopentenecarboxylic acid, 2-hexynoic acid, sorbic acid, allylmalonic acid, allylmalonic anhydride, 3-methyl-4-pentenoic acid, 2-hexenoic acid, 3-hexenoic acid, 4-hexenoic acid, 3-(trimethylsilyl)propynoic acid, 3-(dimethylvinylsilyl)propynoic acid, 2-methylglutaric acid, 2-vinylglutaric acid, 3-allylglutaric acid, 3-vinylglutaric acid, 2-allylglutaric acid, dichlorobenzoic acid, dibromobenzoic acid, diiodobenzoic acid, bromochlorobenzoic acid, bromofluorobenzoic acid, bromoiodobenzoic acid, 6-heptynoic acid, 2,2-dimethyl-4-pentenoic acid, 6-heptenoic acid, 2,2-dimethylglutaric acid, 3,3-dimethylglutaric acid, heptanedioic acid, bromomethylbenzoic acid, chloromethylbenzoic acid, octenoic acid, phenylpropionic acid, sebacic acid, decanoic acid, decenoic acid, 10-bromodecanoic acid, 2-bromodecanoic acid, undecanoic acid, 10-undecenoic acid, 10-undecynoic acid, dodecanoic acid, dodecanedioic acid, 12-bromododecanoic acid, 2-bromododecanoic acid, 2-bromohexadecanoic acid, 16-bromohexadecanoic acid, linolenic acid, elaidic acid, oleic acid, arachidonic acid, erucic acid, 3-allyldihydrofuran-2,5-dione, 3-vinyldihydrofuran-2,5-dione, and also the methyl, ethyl, trimethylsilyl, triethylsilyl, and siloxy esters of the aforementioned carboxylic acids. Preferably, the carboxylic acid used contains an unsaturated group accessible to hydrosilylation. With the help of hydrosilylation catalysts, preferably those which contain platinum, reaction with Si—H-containing cyclo-, oligo- or polysiloxanes is performed. Preference is given to using carboxylic acid derivatives which no longer have an acidic hydrogen atom in the molecule (carboxylic acid esters and anhydrides, lactones). In a second reaction step, the vinyl group or vinyl groups can be introduced into compound (X) through suitable reactions. An example of this is the equilibration reaction between siloxanes known in the prior art. Through the selection of the siloxanes to be equilibrated, the compound from carboxylic acid or derivatives thereof obtained in the first step is reacted with a cyclo-, oligo- or polysiloxane which can carry both terminal and/or chain-position, aliphatically unsaturated groups.

In the silicone compositions according to the invention, it is possible to use peroxide-, addition- or condensation-crosslinking silicone compositions if they contain corresponding amounts of components (X).

In a preferred embodiment, silicone compositions according to the invention are addition-crosslinking, comprising, besides component (X)
at least one each of compound (A), (B) and (D),
at least one compound each of (C) and (D), and
at least one compound each of (A), (B), (C) and (D),
where
m(A) is an organic compound or an organosilicon compound, containing at least two radicals with aliphatic carbon-carbon multiple bonds,
(B) is an organosilicon compound, containing at least two Si-bonded hydrogen atoms,
(C) is an organosilicon compound, containing SiC-bonded radicals with aliphatic carbon-carbon multiple bonds and Si-bonded hydrogen atoms, and
(D) is a hydrosilylation catalyst.

The addition-crosslinking silicone compositions according to the invention may be single-component silicone compositions or else two- or multi-component silicone compositions.

In two-component compositions, the individual components of the compositions according to the invention can contain all of the constituents in any desired combination, generally with the proviso that one component does not simultaneously comprise siloxanes with an aliphatic multiple bond, siloxanes with Si-bonded hydrogen and catalyst, i.e. essentially not simultaneously the constituents (A), (B) and (D) or (C) and (D). However, the compositions according to the invention are preferably single-component compositions.

As is known, the compounds (A) and (B) or (C) used in the compositions according to the invention are selected such that a crosslinking is possible. Thus, for example, compound (A) has at least two aliphatically unsaturated radicals and (B) has at least three Si-bonded hydrogen atoms, or compound (A) has at least three aliphatically unsaturated radicals and siloxane (B) has at least two Si-bonded hydrogen atoms, or else instead of compound (A) and (B), siloxane (C) is used which has aliphatically unsaturated radicals and Si-bonded hydrogen atoms in the aforementioned ratios. Mixtures of (A) and (B) and (C) with the aforementioned ratios of aliphatically unsaturated radicals and Si-bonded hydrogen atoms are also possible.

The compound (A) used according to the invention can be a silicon-free organic compound with preferably at least two aliphatically unsaturated groups, and can be an organosilicon compound with preferably at least two aliphatically unsaturated groups, or else mixtures thereof.

Examples of silicon-free organic compounds (A) are 1,3,5-trivinylcyclohexane, 2,3-dimethyl-1,3-butadiene, 7-methyl-3-methylene-1,6-octadiene, 2-methyl-1,3-butadiene, 1,5-hexadiene, 1,7-octadiene, 4,7-methylene-4,7,8,9-tetrahydroindene, methylcyclopentadiene, 5-vinyl-2-norbornene, bicyclo[2.2.1]hepta-2,5-diene, 1,3-diisopropenylbenzene, vinyl-group-containing polybutadiene, 1,4-divinylcyclohexane, 1,3,5-triallylbenzene, 1,3,5-trivinylbenzene, 1,2,4-trivinyl-cyclohexane, 1,3,5-triisopropenylbenzene, 1,4-divinylbenzene, 3-methyl-heptadiene-(1,5), 3-phenyl-hexadiene-(1,5), 3-vinyl-hexadiene-(1,5) and 4,5-dimethyl-4,5-diethyloctadiene-(1,7), N,N′-methylene-bisacrylamide, 1,1,1-tris(hydroxymethyl)propane triacrylate, 1,1,1-tris(hydroxymethyl)propane trimethacrylate, tripropylene glycol diacrylate, diallyl ether, diallylamine, diallyl carbonate, N,N′-diallylurea, triallylamine, tris(2-methylallyl)amine, 2,4,6-triallyloxy-1,3,5-triazine, triallyl-s-triazine-2,4,6(1H,3H,5H)-trione, diallyl malonate, polyethylene glycol diacrylate, polyethylene glycol dimethacrylate, poly(propylene glycol)methacrylate.

Preferably, the silicon compositions according to the invention comprise, as constituent (A), at least one aliphatically unsaturated organosilicon compound, it being possible to use all of the aliphatically unsaturated organosilicon compounds used hitherto in addition-crosslinking compositions, such as, for example, silicone block copolymers with urea segments, silicone block copolymers with amide segments and/or imide segments and/or ester/amide segments and/or polystyrene segments and/or silarylene segments and/or carborane segments and silicone graft copolymers with ether groups.

The organosilicon compounds (A) that have SiC-bonded radicals with aliphatic carbon-carbon-multiple bonds used are preferably linear or branched organopolysiloxanes of units of the general formula (II)

R⁴ₐR⁵_{b}SiO_{(4-a-b)/2} (II)

where
R⁴, independently of one another, are an organic or inorganic radical free from aliphatic carbon-carbon-multiple bonds,
R⁵, independently of one another, are a monovalent, substituted or unsubstituted, SiC-bonded hydrocarbon radical with at least one aliphatic carbon-carbon-multiple bond,
a is 0, 1, 2 or 3, and
b is 0, 1 or 2,
with the proviso that the sum a+b is less than or equal to 3 and at least 2 radicals R⁵ are present per molecule.

Radicals R⁴ may be mono- or polyvalent radicals, with the polyvalent radicals, such as, for example, bivalent, trivalent and tetravalent radicals, then joining together several, for example two, three or four, siloxy units of the formula (II).

Further examples of R⁴ are the monovalent radicals —F, —Cl, —Br, OR⁶, —CN, —SCN, —NCO and SiC-bonded, substituted or unsubstituted hydrocarbon radicals which may be interrupted with oxygen atoms or the group —C(O)—, and also bivalent radicals Si-bonded on both sides according to formula (II). If radicals R⁴ are SiC-bonded substituted hydrocarbon radicals, preferred substituents are halogen atoms, phosphorus-containing radicals, cyano radicals, —OR⁶, —NR⁶—, —NR⁶₂, —NR⁶—C(O)—NR⁶₂, —C(O)—NR⁶₂, —C(O)R⁶, —C(O)OR⁶, —SO₂-Ph and —C₆F₅. Here, R⁶ are, independently of one another, hydrogen or a monovalent hydrocarbon radicals having 1 to 20 carbon atoms, and Ph is the phenyl radical.

Examples of radicals R⁴ are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical, cycloalkyl radicals such as the cyclopentyl, cyclohexyl, cycloheptyl and methylcyclohexyl radicals, aryl radicals such as the phenyl, naphthyl, anthryl and phenanthryl radicals, alkaryl radicals such as the o-, m-, and p-tolyl radicals, xylyl radicals and ethylphenyl radicals, and aralkyl radicals such as the benzyl radical, and the α- and the β-phenylethyl radicals.

Examples of substituted radicals R⁴ are haloalkyl radicals, such as the 3,3,3-trifluoro-n-propyl radical, the 2,2,2,2′,2′,2′-hexafluoroisopropyl radical, the heptafluoroisopropyl radical, haloaryl radicals, such as the o-, m- and p-chlorophenyl radical, —(CH₂)—N(R⁶)C(O)NR⁶₂, —(CH₂)ₒ—C(O)NR⁶₂, —(CH₂)ₒ—C(O)R⁶, —(CH₂)ₒ—C(O)OR⁶, —(CH₂)ₒ—C(O)NR⁶₂, —(CH₂)—C(O)—(CH₂)ₚC(O)CH₃, —(CH₂)—O—CO—R⁶, —(CH₂)—NR⁶—(CH₂)ₚ—NR⁶₂, —(CH₂)ₒ—O—(CH₂)ₚCH (OH) CH₂OH, —(CH₂)ₒ(OCH₂CH₂)ₚOR⁶, —(CH₂)ₒ—SO₂-Ph and —(CH₂)ₒ—O—C₆F₅, where R⁶ and Ph corresponds to the meaning given for them above and o and p are identical or different integers between 0 and 10.

Examples of R⁴ being bivalent radicals Si-bonded on both sides according to formula (II) are those which are derived from the monovalent examples specified above for radical R⁴ by virtue of the fact that an additional bonding takes place by substitution of a hydrogen atom. Examples of such radicals are —(CH₂)—, —CH(CH₃)—, —C(CH₃)₂—, —CH(CH₃)—CH₂—, —C₆H₄—, —CH(Ph)—CH₂—, —C(CF₃)₂—, —(CH₂)ₒ—C₆H₄—(CH₂)ₒ—, —(CH₂)ₒ—C₆H₄—C₆H₄—(CH₂)ₒ—, —(CH₂O)ₚ, (CH₂CH₂O)ₒ, —(CH₂)ₒ—Oₓ—C₆H₄—SO₂—C₆H₄—Oₓ—(CH₂)ₒ—, where x is 0 or 1, and Ph, o and p have the meaning specified above.

Preferably, radical R⁴ is a monovalent SiC-bonded, optionally substituted hydrocarbon radical having 1 to 18 carbon atoms free from aliphatic carbon-carbon-multiple bonds, more preferably a monovalent SiC-bonded hydrocarbon radical having 1 to 6 carbon atoms free from aliphatic carbon-carbon-multiple bonds, and in particular the methyl or phenyl radical.

Radical R⁵ may be any desired groups accessible to an addition reaction (hydrosilylation) with an SiH-functional compound.

If radicals R⁶ are SiC-bonded, substituted hydrocarbon radicals, the substituents are preferably halogen atoms, cyano radicals and —OR⁶, where R⁶ has the aforementioned meaning.

Preferably, radicals R⁵ are alkenyl and alkynyl groups having 2 to 16 carbon atoms, such as vinyl, allyl, methallyl, 1-propenyl, 5-hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl and styryl radicals, with vinyl, allyl and hexenyl radicals being most preferably used.

The molecular weight of the constituent (A) can vary within wide limits, for example between 10² and 10⁶ g/mol. Thus, the constituent (A) can be, for example, a relatively low molecular weight alkenyl-functional oligosiloxane, such as 1,2-divinyltetramethyldisiloxane, but also a highly polymeric polydimethylsiloxane which has chain-positioned or terminal Si-bonded vinyl groups, e.g. with a molecular weight of 10⁵ g/mol (number-average determined by means of NMR). The structure of the molecules forming the constituent (A) is also not fixed; in particular, the structure of a more highly molecular, i.e. oligomeric or polymeric siloxane, may be linear, cyclic, branched or else resin-like, network-like. Linear and cyclic polysiloxanes are preferably composed of units of the formulae R⁴₃SiO_{1/2}, R⁵R⁴₂SiO_{1/2}, R⁵R⁴SiO_{1/2} and R⁴₂SiO_{2/2}, where R⁴ and R⁵ have the meanings given above. Branched and network-like polysiloxanes additionally contain trifunctional and/or tetrafunctional units, with those of the formulae R⁴SiO_{3/2}, R⁵SiO_{3/2} and SiO_{4/2} being preferred. Mixtures of different siloxanes satisfying the criteria of constituent (A) can of course also be used.

As component (A), particular preference is given to the use of vinyl-functional, essentially linear polydiorganosiloxanes with a viscosity of 0.01 to 500,000 Pa·s, more preferably from 0.1 to 100,000 Pa·s, in each case at 25° C.

As organosilicon compound(s) (B), it is possible to use all hydrogen-functional organosilicon compounds which have also hitherto been used in addition-crosslinkable compositions.

The organopolysiloxanes (B) that have Si-bonded hydrogen atoms are preferably linear, cyclic or branched organopolysiloxanes of units of the general formula (III)

R⁴_{c}H_{d}SiO_{(4-c-d)/2} (III)

where
R⁴ has the aforementioned meaning,
c is 0, 1, 2 or 3 and
d 0, 1 or 2,

with the proviso that the sum of c+d is less than or equal to 3 and at least two Si-bonded hydrogen atoms are present per molecule.

Preferably, the organopolysiloxane (B) used according to the invention comprise Si-bonded hydrogen in the range from 0.04 to 1.7 percent by weight, based on the total weight of the organopolysiloxane (B).

The molecular weight of the constituent (B) can likewise vary within wide limits, for example between 10² and 10⁶ g/mol. Thus, the constituent (B) can for example be a relatively low molecular weight SiH-functional oligosiloxane, such as tetramethyldisiloxane, but also a highly polymeric polydimethylsiloxane that has chain-positioned or terminal SiH-groups, or a silicone resin that has SiH-groups.

The structure of the molecules forming the constituent (B) is also not fixed; in particular, the structure of a more highly molecular, i.e. oligomeric or polymeric SiH-containing siloxane may be linear, cyclic, branched or else resin-like, network-like. Linear and cyclic polysiloxanes (B) are preferably composed of units of the formulae R⁴₃SiO_{1/2}, HR⁴₂SiO_{1/2}, HR⁴SiO_{2/2} and R⁴₂SiO_{2/2}, where R⁴ has the meaning given above. Branched and network-like polysiloxanes additionally comprise trifunctional and/or tetrafunctional units, preference being given to those of the formulae R⁴SiO_{3/2}, HSiO_{3/2} and SiO_{4/2}, where R⁴ has the meaning given above.

It is of course also possible to use mixtures of different siloxanes meeting the criteria of constituent (B). In particular, the molecules forming the constituent (B) can optionally additionally also contain aliphatically unsaturated groups in addition to the obligatory SiH-groups. Particular preference is given to the use of low molecular weight SiH-functional compounds such as tetrakis(dimethylsiloxy)silane and tetramethylcyclotetrasiloxane, as well as more highly molecular, SiH-containing siloxanes, such as poly(hydrogenmethyl)siloxanes and poly(dimethylhydrogenmethyl)siloxanes with a viscosity at 25° C. of from 10 to 10,000 mPa·s, or analogous SiH-containing compounds in which some of the methyl groups are replaced by 3,3,3-trifluoropropyl or phenyl groups.

Constituent (B) is preferably present in the crosslinkable silicone compositions according to the invention in an amount such that the molar ratio of SiH-groups to aliphatically unsaturated groups from (A) is 0.1 to 20, more preferably between 1.0 and 5.0.

The components (A) and (B) used according to the invention are standard commercial products and/or can be prepared by processes customary in chemistry.

Instead of component (A) and (B), the silicone compositions according to the invention can comprise organopolysiloxanes (C) which simultaneously have aliphatic carbon-carbon-multiple bonds and Si-bonded hydrogen atoms. The silicone compositions according to the invention can also comprise all three components (A), (B) and (C).

If siloxanes (C) are used, these are preferably those of units of the general formulae (IV), (V) and (VI)

R⁴_{f}SiO_{4/2} (IV)

R⁴_{g}R⁵SiO_{3-g/2} (V)

R⁴ₕHSiO_{3-h/2} (VI)

where
R⁴ and R⁵ have the meaning given for them above,
f is 0, 1, 2 or 3,
g is 0, 1 or 2 and
h is 0, 1 or 2,
   with the proviso that at least 2 radicals R⁵ and at least 2 Si-bonded hydrogen atoms are present per molecule.

Examples of organopolysiloxanes (C) are those made from SO_{4/2}, R⁴₃SiO_{1/2}, R⁴₂R⁵SiO_{1/2} and R⁴₂HSiO_{1/2} units, so-called MP resins, where these resins can additionally contain R⁴SiO_{3/2} and R⁴₂SiO units, as well as linear organopolysiloxanes essentially consisting of R⁴₂R⁵SiO_{1/2}, R⁴₂SiO and R⁴HSiO units where R⁴ and R⁵ have the aforementioned meaning.

The organopolysiloxanes (C) preferably have an average viscosity of from 0.01 to 500,000 Pa·s, more preferably 0.1 to 100,000 Pa·s, in each case at 25° C. Organopolysiloxanes (C) can be prepared by methods customary in chemistry.

As hydrosilylation catalyst (D), it is possible to use all catalysts known to the prior art. Component (D) may be a platinum group metal, for example platinum, rhodium, ruthenium, palladium, osmium or iridium, an organometallic compound or a combination thereof. Examples of component (D) are compounds such as hexachloroplatinic(IV) acid, platinum dichloride, platinum acetylacetonate and complexes of these compounds which are encapsulated in a matrix or a core/shell-like structure.

Platinum complexes with low molecular weight organopolysiloxanes include 1,3-diethenyl-1,1,3,3-tetramethyldisiloxane complexes with platinum. Further examples are platinum phosphite complexes, platinum phosphine complexes or alkylplatinum complexes. These compounds may be encapsulated in a resin matrix.

To catalyze the hydrosilylation reaction of the components (A) and (B), the concentration of component (D) is sufficient upon activation in order to produce the heat required here in the described process. The amount of component (D) can be between 0.1 and 1000 parts per million (ppm), 0.5 and 100 ppm or 1 and 25 ppm of the platinum group metal, depending on the total weight of the component. The curing rate may be low if the constituent of the platinum group metal is below 1 ppm. The use of more than 100 ppm of the platinum group metal is uneconomical or can reduce the stability of the adhesive formulation.

In a further embodiment, the crosslinkable silicone compositions according to the invention can also be crosslinked peroxidically. In this case, the silicone composition consists at least of the components (A) and (H). In this connection, between 0.1 and 20% by weight of component (H) are preferably present in the silicone compositions according to the invention. As crosslinker in the context of component (H), it is possible to use all peroxides that are typical and correspond to the prior art. Examples of the component (H) are dialkyl peroxides, such as 2,5-dimethyl-2,5-di(tert-butylperoxy)hexane, 1,1-di(tert-butylperoxy)cyclo-hexane, 1,1-di(tert-butylperoxy)-3,3,5-trimethylcyclo-hexane, a-hydroxyperoxy-a′-hydroxydicyclohexyl peroxide, 3,6-dicyclohexylidene-1,2,4,5-tetroxane, di-tert-butyl peroxide, tert-butyl-tert-triptyl peroxide and tert-butyl-triethyl-5-methyl peroxide, diaralkyl peroxides such as dicumyl peroxide, alkylaralkyl peroxides such as tert-butylcumyl peroxide and a,a′-di(tert-butylperoxy)-m/p-diisopropylbenzene, alkylacyl peroxides, such as t-butyl perbenzoate, and diacyl peroxides, such as dibenzoyl peroxide, bis(2-methylbenzoyl peroxide), bis(4-methylbenzoyl peroxide) and bis(2,4-dichlorobenzoyl peroxide). Preference is given to using vinyl-specific peroxides, the most important representatives of which are the dialkyl and diaralkyl peroxides. Particular preference is given to using 2,5-dimethyl-2,5-di(tert-butylperoxy)hexane and dicumyl peroxide. It is also possible to use individual peroxides or mixtures of different peroxides (H). The content of constituent (H) in the silicone compositions according to the invention is preferably between 0.1 and 5.0% by weight, more preferably between 0.5 and 1.5% by weight. Preference is therefore given to the crosslinkable silicone compositions according to the invention characterized in that the crosslinker (H) is present from 0.1 to 5.0% by weight and is an organic peroxide or a mixture of organic peroxides.

In a further embodiment, the crosslinkable silicone compositions according to the invention can also be crosslinked by adding component(X) to condensation-crosslinking silicone compositions. Condensation-crosslinking silicone compositions have been known to the person skilled in the art for a long time. A more detailed description can be found, for example, in EP0787766A1.

All of the peroxide-, addition- and condensation-crosslinking silicone compositions according to the invention described above can optionally comprise strengthening fillers, as a component (E), such as fumed or precipitated silicas with BET surface areas of at least 50 m²/g, as well as carbon blacks and activated carbons such as furnace black and acetylene black, with preference being given to fumed and precipitated silicas with BET surface areas of at least 50 m²/g. The specified silica fillers can have a hydrophilic character or be hydrophobicized by known processes. The content of actively strengthening filler (E) in the crosslinkable composition according to the invention is in the range from 0 to 70% by weight, preferably 0 to 50% by weight.

Preferably, the crosslinkable silicone compositions according to the invention are characterized in that the filler (E) has been surface-treated. The surface treatment is achieved by processes known in the prior art for the hydrophobicization of finely divided fillers. The hydrophobicization can take place, for example, either prior to the incorporation into the polyorganosiloxane or else in the presence of a polyorganosiloxane according to the in situ process. Both processes can be carried out either in the batch process or else continuously. Hydrophobicizing agents preferably used are organosilicon compounds which are able to react with the filler surface to form covalent bonds or are permanently physisorbed onto the filler surface. Examples of hydrophobicizing agents are alkylchlorosilanes such as methyltrichlorosilane, dimethyldichlorosilane, trimethylchlorosilane, octyltrichlorosilane, octadecyltrichlorosilane, octylmethyldichlorosilane, octadecylmethyldichlorosilane, octyldimethylchlorosilane, octadecyldimethylchlorosilane and tert-butyldimethylchlorosilane; alkylalkoxysilanes such as dimethyldimethoxysilane, dimethyldiethoxysilane, trimethylmethoxysilane and trimethylethoxysilane; trimethylsilanol; cyclic diorgano(poly)siloxanes such as octamethylcyclotetrasiloxane and decamethylcyclopentasiloxane; linear diorganopolysiloxanes such as dimethylpolysiloxanes with trimethylsiloxy end groups, and dimethylpolysiloxanes with silanol or alkoxy end groups; disilazanes such as hexaalkyldisilazanes, in particular hexamethyldisilazane, divinyltetramethyldisilazane, bis(trifluoropropyl)tetramethyldisilazane; cyclic dimethylsilazanes, such as hexamethylcyclotrisilazane. It is also possible to use mixtures of the hydrophobicizing agents specified above. In order to increase the rate of the hydrophobicization, catalytically active additives, such as, for example, amines, metal hydroxides and water, can also optionally be added.

The hydrophobicization can take place, for example, in one step using one hydrophobicizing agent or a mixture of several hydrophobicizing agents, but also using one or more hydrophobicizing agents in several steps.

As a consequence of a surface treatment, preferred fillers (E) have a carbon content of at least 0.01 to at most 20% by weight, preferably between 0.1 and 10% by weight, and more preferably between 0.5 to 5% by weight. Particular preference is given to crosslinkable silicone compositions which are characterized in that the filler (E) is a surface-treated silica having 0.01 to 2% by weight of Si-bonded, aliphatically unsaturated groups. For example, these may be Si-bonded vinyl groups. In the silicone composition according to the invention, the constituent (E) is used preferably as an individual filler or likewise preferably as a mixture of several finely divided fillers.

The silicone compositions according to the invention can, if desired, comprise as constituents further additives (F) in a fraction of up to 70% by weight, preferably 0.0001 to 40% by weight. These additives (F) may be e.g. inactive fillers, resin-like polyorganosiloxanes which are different from the siloxanes (A), (B), (C), (E) and (X), fungicides, fragrances, rheological additives, inhibitors and stabilizers for the targeted adjustment of processing time, onset temperature and crosslinking rate, corrosion inhibitors, oxidation inhibitors, light protection agents, flame retardants and agents for influencing the electrical properties, dispersion auxiliaries, solvents, adhesion promoters, pigments, dyes, plasticizers, organic polymers, heat stabilizers etc. These include additives such as quartz flour, diatomaceous earth, clays, chalk, lithopone, graphite, metal oxides, metal carbonates, metal sulfates, metal salts of carboxylic acids, metal dusts, fibers, such as glass fibers, plastic fibers, plastic powders, metal dusts, dyes, pigments etc.

Moreover, these fillers may be heat-conducting or electrically conducting. Examples of heat-conducting fillers are aluminum nitride; aluminum oxide; barium titanate; beryllium oxide; boron nitride; diamond; graphite; magnesium oxide; particulate metals such as, copper, gold, nickel or silver; silicon carbide; tungsten carbide; zinc oxide, and combinations thereof. Heat-conducting fillers are known in the prior art and are commercially available. For example, CB-A20S and Al-43-Me are aluminum oxide fillers in different particle sizes which are commercially available from Showa-Denko, and AA-04, AA-2 and AA18 are aluminum oxide fillers which are commercially available from Sumitomo Chemical Company. Silver fillers are commercially available from Metalor Technologies U.S.A. Corp. of Attleboro, Mass., U.S.A. Boron nitride fillers are commercially available from Advanced Ceramics Corporation, Cleveland, Ohio, U.S.A. It is also possible to use a combination of fillers with different particle sizes and different particle size distribution.

Inhibitors and stabilizers serve for the targeted adjustment of the processing time, onset temperature and crosslinking rate of the silicone compositions according to the invention. These inhibitors and stabilizers have been known for a long time in the prior art. Examples of customary inhibitors are acetylenic alcohols, such as 1-ethynyl-1-cyclohexanol, 2-methyl-3-butyn-2-ol and 3,5-dimethyl-1-hexyn-3-ol, 3-methyl-1-dodecyn-3-ol, polymethylvinylcyclosiloxanes such as 1,3,5, 7-tetravinyltetramethyltetracyclosiloxane, low molecular weight silicone oils with methylvinyl-SiO_{1/2} groups and/or R₂vinylSiO_{1/2} end groups, such as divinyltetramethyldisiloxane, tetravinyldimethyldisiloxane, trialkyl cyanurates, alkyl maleates, such as diallyl maleates, dimethyl maleate and diethyl maleate, alkyl fumarates, such as diallyl fumarate and diethylfumarate, organic hydroperoxides such as cumene hydroperoxide, tert-butyl hydroperoxide and pinane hydroperoxide, organic peroxides, organic sulfoxides, organic amines, diamines and amides, phosphates and phosphites, nitriles, triazoles, diaziridines and oximes. The effect of these inhibitor additives (F) depends on their chemical structure, meaning that the concentration has to be determined individually. Inhibitors and inhibitor mixtures are preferably added in a quantitative fraction of from 0.00001% to 5%, based on the total weight of the mixture, preferably 0.00005 to 2% and more preferably 0.0001 to 1%.

The silicone composition can additionally optionally comprise a solvent (G). However, it should be ensured that the solvent (G) has no disadvantageous effects on the overall system. Suitable solvents (G) are known in the prior art and are commercially available. The solvent (G) can be, for example, an organic solvent having 3 to 20 carbon atoms. Non-limiting examples of solvents (G) include aliphatic hydrocarbons such as nonane, decalin and dodecane; aromatic hydrocarbons such as mesitylene, xylene and toluene; esters such as ethyl acetate and butyrolactone; ethers such as n-butyl ether and polyethylene glycol monomethyl ether; ketones such as methyl isobutyl ketone and methyl pentyl ketone; silicone fluids such as linear, branched and cyclic polydimethylsiloxanes, and combinations of these solvents. The optimum concentration of a specific solvent (G) in the silicone composition can be determined easily by means of routine experiments. Depending on the weight of the compound, the amount of solvent (G) can be between 0 and 95% or between 1 and 95%.

The crosslinkable silicone compositions according to the invention have the advantage that they can be prepared in a simple process using readily accessible starting materials and therefore in an economical manner. The crosslinkable silicone compositions according to the invention have the further advantage that they have good storage stability, even as a single-component formulation, at 25° C. and ambient pressure, and rapidly crosslink only at elevated temperature. The silicone compositions according to the invention have the advantage that, in the case of a two-component formulation, they produce, after mixing the two components, a crosslinkable silicone mass, the processability of which is retained over a long period at 25° C. and ambient pressure, i.e. exhibit extremely long pot life, and rapidly crosslink only at elevated temperature.

By means of processes known in the prior art, the silicone rubbers according to the invention are produced by crosslinking the silicone compositions according to the invention. Silicone rubbers that can be produced for medical products are, for example, face masks, valves, hoses, catheters, lining materials, bandages, prostheses, dressing materials. The medical products produced in this way have a long-lasting suppression of the occupation of their surfaces by bacteria and consequently a significantly reduced risk of infection for the patient during their use.

### EXAMPLES

In the examples described below, all of the data for parts and percentages are based on weight, unless stated otherwise. Unless stated otherwise, the examples below are carried out at a pressure of the ambient atmosphere, i.e. at about 1000 hPa, and at room temperature, i.e. at about 20° C., or at a temperature which is established upon combining the reactants at room temperature without additional heating or cooling. Hereinbelow, all of the viscosity data refer to a temperature of 25° C. The examples below illustrate the invention without having a limiting effect.

The following abbreviations are used:
Cat. platinum catalyst
Ex. example
No. number
PDMS polydimethylsiloxane
LSR liquid silicone rubber
HTC high-temperature-crosslinking
% by weight percent by weight, w/w
M unit monofunctional siloxane radical, R₃SiO_{1/2}
D unit difunctional siloxane radical, R₂SiO_{2/2}
T unit trifunctional siloxane radical, R₃SiO_{3/2}
Q unit tetrafunctional siloxane radical, SiO_{4/2}
   where R is an organic radical.

### Example 1

### Synthesis of the compound (X):

One possible synthesis route for incorporating functional groups which permit a bonding to the PDMS network is the equilibration reaction of suitable precursors that is widespread in silicone chemistry. This type of bonding constitutes, by way of example, one option to produce the compound (X) and should not have a limiting effect on the scope of protection of the application since the synthesis route exhibits no influence on the effectiveness.

Stage 1:

Preparation of an α,ω-succinic anhydride-functional silicone by hydrosilylation of 2-allylsuccinic anhydride and an α,ω-Si—H-terminal polydimethylsiloxane with an average chain length of 50 D units: under precious metal catalysis (metals of the platinum group, preference being given to platinum compounds), the reaction of the H-terminal silicone polymer with 2-allylsuccinic anhydride takes place preferably at about 90-110° C. The synthesis takes place with equimolar feed based on the functional groups (Si—H and allyl). An excess or deficit of the individual reactants is likewise possible.

Stage 2:

Functionalization for the bonding to silicone elastomers: the product from stage 1 is reacted with an Si-vinyl-functional polymer with the help of the equilibration reaction, where the vinyl-functional polymer can carry both chain-position and terminal vinyl groups. The molar ratio of the two starting materials can be selected between 1:100 to 100:1, where preferably a ratio between 1:20 to 5:1 and particularly preferably a ratio between 1:10 and 2:1 is selected. The equilibration itself can be carried out by all methods known in the prior art, such as, for example, acid- or base-catalyzed equilibration or using phosphazenes. For this example, 0.45 mol of α,ω-succinic anhydride-functional silicone is equilibrated with 4.5 mol of divinyldisiloxane with the help of a phosphazene with the average molecular formula PNCl₂. After heating the mixture to 100° C. to 120° C., 400 ppm of equilibration catalyst (based on the total weight of the reactants) are added in two tranches of 200 ppm each. After stirring for two hours, the catalyst is quenched by adding divinyltetramethyldisilazane, and volatile constituents are removed by applying oil pump vacuum.

### Example 2

### Synthesis of the compound (X):

Stage 1: Preparation of an α,ω-functional silicone by hydrosilylation of acrylic acid trimethylsilyl ester (propenoic acid trimethylsilyl ester) and an α,ω-Si—H-terminal polydimethylsiloxane with an average chain length of 50 D units: under precious metal catalysis (Pt metals), the reaction of the H-terminal silicone polymer with acrylic acid trimethylsilyl ester takes place preferably at about 90-110° C. The synthesis takes place with equimolar feed based on the functional groups (Si—H and vinyl). An excess or deficit of the individual reactants is likewise possible.

Stage 2: Functionalization for the bonding to silicone elastomers analogously to example 1, where the ratio of carboxylic acid ester groups:vinyl groups=1:5.

### Example 3

### Synthesis of the compound (X):

Proceeding from undecenoic acid triisopropylsilyl ester, the compound (X) is prepared analogously to example 1, where, in stage 2, the ratio of carboxylic acid ester groups:vinyl groups=1:2.

### Example C4 (Comparative Example)

Silicone base composition 1 (LSR silicone): commercially available LSR mixture ELASTOSIL® 3003/40 A/B. The crosslinking of the material takes place by compression at 165° C. for 10 min.

### Example 5

Compound (X) and additional Si—H crosslinker is added to the commercially available LSR mixture ELASTOSIL® 3003/40 A/B from example 4. By incorporating the vinyl groups from compound (X), a balancing of the functional groups is required, for which reason a linear Si—H comb crosslinker with an Si—H content of 4.8 mmol of Si—H per gram is added, where the additionally added amount of Si—H corresponds approximately to the amount of vinyl groups from compound (X) (molar calculation). The crosslinking of the material takes place by compression at 165° C. for 10 min.

In table 1, different compounds (X) at various added amounts are varied and the results are shown.

### Example C6 (Comparative Example)

Silicone base composition 2 (HTC silicone): commercially available, peroxidically crosslinking HTC mixture ELASTOSIL® 401/60 C6. The crosslinking of the material takes place by compression at 165° C. for 10 min, then the material is heated at 200° C. for 4 hours.

### Example 7

Compound (X) is compounded into the commercially available, peroxidically crosslinking HTC mixture ELASTOSIL® R 401/60 C6. The crosslinking of the material takes place by compression at 165° C. for 10 min, then the material is heated at 200° C. for 4 hours. In table 1, different compounds (X) at various added amounts are varied and the results are shown.

### Example C8 (Comparative Example)

Silicone base composition 3 (RTC-2-silicone): commercially available, addition-crosslinking RTC-2 mixture SILPURAN. The crosslinking of the material takes place by heating at 50° C. for 1 h.

### Example 9

Compound (X) is mixed into the commercially available, addition-crosslinking RTC-2 mixture SILPURAN® 2420 A/B. By incorporating the vinyl groups from compound (X), a balancing of the functional groups is required, for which reason HD cyclic (primarily HD5 and HD6) are added, where the additionally added amount of Si—H corresponds approximately to the amount of vinyl groups from compound (X) (molar calculation). The crosslinking of the material takes place by heating to 50° C. for 1 h. In table 1, different compounds 1 at various added amounts are varied and the results are shown.

Test Method

As a result of the covalent bonding of the acid or acid ester groups to the PDMS matrix, test methods based on the diffusion of active substances are unsuitable for characterizing the surface (agar diffusion test or inhibitory zone test). On account of the manifold application options of antimicrobially equipped products, there is hitherto no national or international standard for the testing of products. The behavior of the crosslinked silicone rubber, however, should be tested as far as possible under conditions simulating those encountered in practice, for which reason the effectiveness tests on the occupation of the surface were carried out in accordance with the Japanese standard JIS Z 2801:2000. In this, bacteria are applied in a nutrient solution to the material under investigation and incubated. Following inoculation of the samples, a thin film is pressed on to the inoculum such that the bacteria suspension is spread on the test piece in the thinnest possible layer and consequently the activity of the surface can be tested. The specific effect is based on the difference in germ counts between a sample to which compound (X) has been added and the blank sample which consists of the same base material (without additive thus without compound (X)). The effectiveness of antimicrobial surfaces is defined via the germ reduction achieved within the contact time and is given in log stages. One log stage corresponds to the reduction of the germs by one power of ten (log10). The stated number of bacteria refers to the evaluation of the test by counting.

TABLE 1

| | | Carboxyl | | |
|---|---|---|---|---|
| | | equivalents | | |
| | Silicone | from compound | | Rounded |
| Ex. | from | (X) [mmol/g]/as | Number of | reduction |
| No. | Ex. No. | per Ex. No. | bacteria | [log10] |
| 10 | C4* | — | 2*10⁶ | Blank sample |
| 11 | 5 | 0.01/1 | 1*10⁶ | 0 |
| 12 | 5 | 0.05/1 | 2*10⁶ | 0 |
| 13 | 5 | 0.1/1 | 0 | 6 |
| 14 | 5 | 0.2/1 | 0 | 6 |
| 15 | 5 | 0.5/1 | 0 | 6 |
| 16 | 5 | 1/1 | 0 | 6 |
| 17 | 5 | 0.01/2 | 1*10⁵ | 1 |
| 18 | 5 | 0.05/2 | 1*10³ | 3 |
| 19 | 5 | 0.1/2 | 1*10³ | 3 |
| 20 | 5 | 0.2/2 | 0 | 6 |
| 21 | 5 | 0.5/2 | 0 | 6 |
| 22 | 5 | 0.01/3 | 1*10⁶ | 0 |
| 23 | 5 | 0.05/3 | 1*10⁶ | 0 |
| 24 | 5 | 0.1/3 | 0 | 6 |
| 25 | 5 | 0.5/3 | 0 | 6 |
| 26 | C6* | — | 1*10⁶ | Blank sample |
| 27 | 7 | 0.01/1 | 1.2*10⁶ | 0 |
| 28 | 7 | 0.05/1 | 2*10² | 4 |
| 29 | 7 | 0.1/1 | 0 | 6 |
| 30 | 7 | 0.5/1 | 0 | 6 |
| 31 | 7 | 0.01/2 | 1*10⁵ | 1 |
| 32 | 7 | 0.05/2 | 1*10³ | 3 |
| 33 | 7 | 0.1/2 | 0 | 3 |
| 34 | 7 | 0.5/2 | 0 | 6 |
| 35 | 7 | 0.01/3 | 1*10⁶ | 0 |
| 36 | 7 | 0.05/3 | 1*10⁶ | 0 |
| 37 | 7 | 0.1/3 | 0 | 6 |
| 38 | 7 | 0.5/3 | 0 | 6 |
| 39 | C8* | — | 1.5*10⁶ | Blank sample |
| 40 | 9 | 0.01/1 | 1.2*10⁶ | 0 |
| 41 | 9 | 0.05/1 | 6*10⁵ | 0 |
| 42 | 9 | 0.1/1 | 0 | 2 |
| 43 | 9 | 0.5/1 | 0 | 6 |
| 44 | 9 | 0.01/2 | 1*10⁶ | 0 |
| 45 | 9 | 0.05/2 | 2*10³ | 3 |
| 46 | 9 | 0.1/2 | 0 | 3 |
| 47 | 9 | 0.5/2 | 0 | 6 |
| 48 | 9 | 0.01/3 | 1*10⁶ | 0 |
| 49 | 9 | 0.05/3 | 3*10⁴ | 2 |
| 50 | 9 | 0.1/3 | 0 | 6 |
| 51 | 9 | 0.5/3 | 0 | 6 |

*not according to the invention

### Example 52

### Synthesis of the Compound (X)

Stage 1:

Preparation of a chain-positioned, succinic anhydride-functional silicone by hydrosilylation of 1,1,1,3,5,5,5-heptamethylsilane with allylsuccinic anhydride, preferably at about 90-110° C. The synthesis takes place with equimolar feed based on the functional groups Si—H and allyl. An excess or deficit of the individual reactants is likewise possible. Following the reaction, a purification, for example by distillation, of the reaction product can be performed.

Stage 2:

Functionalization for the bonding to silicone elastomers: the product from stage 1 is reacted with a 1,1,3,3-tetramethyl-1,3-divinyldisiloxane with the help of the equilibration reaction. The molar ratio between 1,1,3,3-tetramethyl-1,3-divinyldisiloxane and the reaction product from stage 1 is at least 2, preferably at least 3. The temperature of the solution must be no more than 138° C. During the equilibration, the products hexamethyldisiloxane and 1,1,2,2,2-pentamethyl-1-vinyldisiloxane are formed and are removed from the mixture during the reaction via the top of the column in order to shift the equilibrium in the direction of the divinyl-functionalized species. The reaction product consists at the end of the reaction of preferably at least 90% divinyl-functionalized monomers: 3-(3-(1,1,3,5,5-pentamethyl-1,5-divinyltrisiloxane-3-yl)propyl)dihydrofuran-2,5-dione. An enrichment of the anhydride-functionalized D-group can take place during the equilibration reaction, although this is unimportant for the intended use. In a preferred embodiment, purification takes place by means of distillation. The equilibration catalyst used is the catalyst with the average molecular formula PNCl₂ used in the examples hitherto.

### Example 53

### Synthesis of the Compound (X)

Introduction of D units into the product from example 52 by equilibration with an α,ω-vinyl-functional polydimethylsiloxane. The chain length of the polydimethylsiloxane used is selected such that the desired number of D groups is incorporated statistically into compound (X). In example 53, the product from example 52 is equilibrated in a ratio of 1:4 with an α,ω-vinyl-functional polydimethylsiloxane with an average chain length of 200 units. The result of this reaction is an inventive α,ω-vinyl-functional polydimethylsiloxane modified in the side position with one or more propyldihydrofuran-2,5-dione groups.

1.-5. (canceled)

6. A biofilm-inhibiting crosslinkable silicone composition which comprises at least one silicone compound (X) of the formula (I) 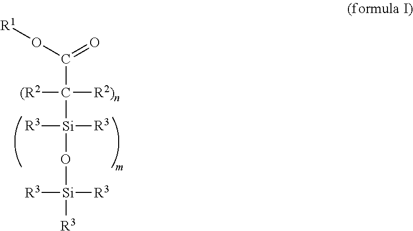
where
R¹ each independently are hydrogen, or a monovalent radical optionally containing heteroatoms,
R² each independently are hydrogen, or a monovalent radical optionally containing heteroatoms,
R³ each independently are hydrogen, or a monovalent radical optionally containing heteroatoms,
n is a number between 1 and 30,
m is a number between 0 and 6000,
with the proviso that, per molecule of the compound (X), at least one R³ is an aliphatically unsaturated double bond or a hydrogen atom, and
with the proviso that the silicone compound (X) is used in amounts such that the silicone composition comprises between 0.005 mmol/g and 2 mmol/g of carboxylic acid groups or carboxylic acid esters or carboxylic anhydrides hydrolyzable to give carboxylic acids.

7. The biofilm-inhibiting crosslinkable silicone composition of claim 6, wherein
R¹ are each independently alkyl-, aryl-, arylalkyl-, alkylaryl-, SiR⁷₃-, or polydimethylsiloxane-,
R² are each independently alkyl-, aryl-, arylalkyl-, alkylaryl-, or R⁸COOR¹,
R³ are each independently alkenyl-, alkenylaryl-, alkyl-, aryl-, arylalkyl-, alkylaryl-, or —OSiR⁷₃,
R⁷ are each independently alkenyl-, alkenylaryl-, alkyl-, aryl-, arylalkyl-, alkylaryl-, or —OSiR⁷₃, and
R⁸ are each independently bivalent alkylene radicals.

8. The biofilm-inhibiting crosslinkable silicone composition as of claim 6, wherein the radicals R¹ are selected from the group consisting of methyl, ethyl, phenyl, silyl, polydimethylsiloxane radicals, and anhydrides or lactones of further carboxyl or hydroxyl groups present in the same molecule.

9. The biofilm-inhibiting crosslinkable silicone composition of claim 6, wherein the radicals R² are selected from the group consisting of hydrogen, methyl, ethyl, phenyl, silyl, polydimethylsiloxane radicals, and anhydrides or lactones of further carboxyl or hydroxyl groups present in the same molecule.

10. The biofilm-inhibiting crosslinkable silicone composition of claim 8, wherein the radicals R² are selected from the group consisting of hydrogen, methyl, ethyl, phenyl, silyl, polydimethylsiloxane radicals, and anhydrides or lactones of further carboxyl or hydroxyl groups present in the same molecule.

11. The biofilm-inhibiting crosslinkable silicone composition of claim 6, wherein the composition is a peroxide-, addition- or condensation-crosslinking silicone composition.

12. The biofilm-inhibiting crosslinkable silicone composition of claim 7, wherein the composition is a peroxide-, addition- or condensation-crosslinking silicone composition.

13. The biofilm-inhibiting crosslinkable silicone composition of claim 8, wherein the composition is a peroxide-, addition- or condensation-crosslinking silicone composition.

14. The biofilm-inhibiting crosslinkable silicone composition of claim 9, wherein the composition is a peroxide-, addition- or condensation-crosslinking silicone composition.

15. The biofilm-inhibiting crosslinkable silicone composition of claim 10, wherein the composition is a peroxide-, addition- or condensation-crosslinking silicone composition.

16. The biofilm-inhibiting crosslinkable silicone composition of claim 6, which is a peroxide catalyzed addition curing composition.

17. The biofilm-inhibiting crosslinkable silicone composition of claim 7, which is a peroxide catalyzed addition curing composition.

18. The biofilm-inhibiting crosslinkable silicone composition of claim 6 which is an addition curable composition catalyzed by a hydrosilylation catalyst.

19. The biofilm-inhibiting crosslinkable silicone composition of claim 7 which is an addition curable composition catalyzed by a hydrosilylation catalyst.

20. A silicone rubber prepared by crosslinking the biofilm-inhibiting silicone composition of claim 6.

21. A silicone rubber prepared by crosslinking the biofilm-inhibiting silicone composition of claim 7.
